(19) United States
(12) Patent Application Publication
(10) Pub. No.: US 2025/0165898 A1
(43) Pub. Date: May 22, 2025

(54) DETECTING DATA ANOMALIES USING RULES AND ARTIFICIAL INTELLIGENCE

(71) Applicant: Walmart Apollo, LLC, Bentonville, AR (US)

(72) Inventors: Kunal Sharma, Bangalore (IN); Amit Jhunjhunwala, Bengaluru (IN); Satish Kumar, Dhanbad (IN); Akash Babulal Patil, Nandurbar (IN); Koustav Mukherjee, Jamshedpur (IN); Animesh Shukla, Lucknow (IN); Gayam Venkateswar Reddy, Bengaluru (IN); Saurav Kumar Chaudhary, Guwahati (IN); Aastha Jaie, Bangalore (IN); Yogishankar Gachinmath, Karnataka (IN)

(21) Appl. No.: 18/947,306

(22) Filed: Nov. 14, 2024

Related U.S. Application Data
(60) Provisional application No. 63/600,496, filed on Nov. 17, 2023.

(51) Int. Cl. G06Q 10/0639; G06Q 10/087

(52) U.S. Cl. CPC G06Q 10/06393; G06Q 10/06395; G06Q 10/087

(57) ABSTRACT

An alert detection system that detects anomalies in business activities, and a method of operating the same. The method includes receiving alert configuration data associated with an alert via an alert configuration interface. The method further includes accessing a data value stored at a data source using a data path of the received alert configuration data and analyzing the accessed data value using at least one of an anomaly detection rule or a trained anomaly detection model associated with the alert. The method further includes determining that the alert is triggered based on analyzing the accessed data value and sending an alert communication of the triggered alert using at least one alert communication channel defined in the received alert configuration data.

### BACKGROUND

Businesses monitor the performance of business activities by measuring various performance metrics. For retail industries, the performance metrics may be number of orders, number of returns, delays in refunds, items out of stock, and many more. Some of these metrics are known, while others are hidden and need intelligence to relate business activities to the performance indicators. Usually, analysts study the data and present insights to the business when the performance metrics are known.

### SUMMARY

Various examples of this disclosure provide a system and/or method for detecting anomalies in business activities. One such method includes receiving alert configuration data associated with an alert via an alert configuration interface. The method further includes accessing a data value stored at a data source using a data path of the received alert configuration data and analyzing the accessed data value using at least one of an anomaly detection rule or a trained anomaly detection model associated with the alert. The method further includes determining that the alert is triggered based on analyzing the accessed data value and sending an alert communication of the triggered alert using at least one alert communication channel defined in the received alert configuration data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system including an alert platform for configuring alerts, detecting triggers of those alerts using an alert detection engine, and sending alert notifications based on the detected triggers;

FIG. 2 is an exemplary block diagram illustrating a processes performed by and/or in association with a system, such as the system FIG. 1;

FIG. 3 is an exemplary block diagram illustrating a processes for rule-based anomaly detection in a system, such as the system of FIG. 1;

FIG. 4 is an exemplary block diagram illustrating processes for machine learning-based anomaly detection and prediction in a system, such as the system of FIG. 1;

FIG. 5 is an exemplary system diagram illustrating a system and associated methods for predicting and/or detecting anomalies using business data;

FIG. 6 is an exemplary system diagram illustrating a system and associated methods for predicting and/or detecting anomalies using business data;

FIG. 7 is an exemplary system diagram illustrating various activities of a retail business and the types of applications and data used by such a business;

FIG. 8 is an exemplary system diagram illustrating a detailed process for onboarding and detecting rules-based alerts;

FIG. 9 is an exemplary block diagram illustrating a detailed process of onboarding and detecting machine learning driven alerts associated univariate anomaly detection models;

FIG. 10 is an exemplary block diagram illustrating a detailed process for onboarding and detecting machine learning-based alerts associated with forecasting and/or custom MIL models;

FIG. 11 is an exemplary block diagram illustrating a process performed by an alert ingestion micro-service;

FIG. 12 is an exemplary block diagram illustrating a process performed by an alert notification micro-service;

FIG. 13 is an exemplary block diagram illustrating a process performed by a real-time alert notification micro-service;

FIG. 14 is an exemplary flow chart illustrating a process for automatically closing alerts;

FIG. 15 is an exemplary flow chart illustrating a method for onboarding an alert and detecting an anomaly based on the onboarded alert; and

FIG. 16 is an exemplary flow chart illustrating a computing apparatus with which the present disclosure is operable.

Corresponding reference characters indicate corresponding parts throughout the drawings.

### DETAILED DESCRIPTION

Business leaders monitor the performance of the business activities by measuring various performance metrics like Net Promotor Score, number of orders, number of returns, delays in refunds, items out of stock, and many more. Some of these metrics are known to business leaders, while others are hidden and need intelligence to relate business activities to the performance indicators. Usually, analysts study the data and present insights to the business leaders when the performance metrics are known. However, in case of unknown scenarios, Artificial Intelligence (AI) has the ability to predict and carve out inferences from data associated with the business activities. The described Cognitive Alerting Platform is a solution which can scale up to a huge volume of data and plug-in data from anywhere across the ecosystem to regularly monitor, detect, alert, and prevent the abnormalities in business. The Cognitive Alerting Platform was developed with the intention to monitor various business activities, detect any deviations from usual behavior, alert the right business stakeholder(s), and auto-heal the problem if possible.

The disclosure includes an alert detection system that detects anomalies in business activities using rules and AI models. The disclosure enables users to onboard custom rules and/or AI models and associated data source information. Further, the alerts generated by the disclosure are customizable and may be distributed to users using a wide variety of different communication channels, such as email or specific APIs. The disclosure is configured to ingest data from various defined data sources, analyze ingested data with defined rules and trained AI models, and to generate alerts based on that analysis. The alerts are managed by the disclosed system, including processes for distributing alerts, deduplicating alerts, and enabling specific users to close alerts, snooze alerts, or otherwise interact with how the alerts are managed by the system. The disclosure includes a self-service user interface (UI) that enables a user to onboard anomalies and business performance indicators that are to be monitored, as well as associated rules and AI models, such that the user is enabled to customize the detection of anomalies and generation of associated alerts.

To monitor the operational excellence in engineering, there are many tools available today, like Splunk, Grafana, xMatters, etc. These tools help engineering teams to monitor the performance of their IT systems. However, it's quite complex to carry out similar monitoring in business activities.

Therefore, the disclosure describes a system which uses a plug and play model to monitor the business activities and detect and prevent any anomalies in the business activities using business rules as well as AI. Monitoring of the business activities is not straightforward, because each business activity is different from others. For example, in an e-commerce business, the activity of fulfilling an order of the customer is different from sourcing inventory from the supplier, organizing the inventory in the warehouse, shipping the inventory to other geo-locations internally and many others. The performance indicators of all of these activities are different as well.

Business leaders monitor the performance of the business by measuring various performance metrics like Net Promotor Score, number of Orders Returned by the customers, delays in refunds, items out of stock, and many more. Some of these metrics are known to business leaders, while others may be hidden and need intelligence to relate business activities to the performance indicators. Usually, analysts study the data to present insights to the business leaders when the performance metrics are known. However, in case of unknown scenarios, the AI models of the disclosure have the ability to predict and carve out inferences from data associated with the business activities. Thus, the disclosure provides a solution that can scale to a huge volume of data, is agile to plug-in data from anywhere across the ecosystem to regularly monitor and can detect and prevent the anomalies whether the performance indicators are known or unknown.

An implementation of the disclosure includes data sourcing from public and/or private databases and/or other data sources; cleansing, transforming, and/or processing data using data engineering concepts and processes; training, validation, and/or deployment of AI models using the data; using data ingestion techniques to store data, deduplicate data, and/or use versioning and validation techniques on the data; sharing of data and associated generated information is provided using a wide variety of different communication channels using customized user interfaces; and onboarding of custom alert configurations based on known business performance indicators is enabled.

Further, in some examples, the disclosure includes onboarding interfaces that enable users to configure alerts on their own, including scenarios where users are aided in the generation of alert configurations using a generative AI. Such generative AI enables users to draft alert rules using plain language and rely on the generative AI to convert the plain language to the equivalent rule code and/or syntax.

In some examples, the disclosure includes both anomaly detection and forecasting using open-source machine learning (ML) models that have been trained and/or fine-tuned using historical and/or generated training data. Thus, in addition to enabling mitigating action to be taken when an anomaly is detected, undesirable anomalies can be predicted and entirely prevented using the disclosure in some cases.

Additionally, in some examples, the disclosure is configured to be flexible with respect to data sources used. The disclosed systems and methods enable users to customize the alerts to include data paths to a wide variety of different data sources, including public and private data sources, databases, cloud-based data sources, and many other types.

In some examples, the disclosure is configured to monitor and maintain alerts throughout an alert lifecycle. In some such examples, an alert is open, suspended, or closed. Users can be sent alerts and/or enabled to control the state of alerts (e.g., by closing alerts, “snoozing” alerts so that they appear again at a later time, or the like). Further, users are enabled to provide feedback on alerts that can later be used to fine-tune any ML models that are being used with respect to those alerts.

Further, in some examples, the disclosure enables the sending of alerts via a wide variety of communication channels. For example, alert information, such as summaries and/or notification information can be sent via email and/or JIRA, while real-time notifications are provided via an event streaming platform. Existing and/or custom platform UIs and APIs are enabled to provide a rich user experience and simplified integration with the alerts from the disclosed systems and methods.

In some examples, the disclosure enables the recording and analysis of alert data that can be used with respect to business key performance indicators (KPIs). Such KPIs can be monitored by tracking the triggering of alerts. Then, the disclosure enables the configuration of second-level alerts based on the monitoring KPIs, such that users are alerted based on the metrics of such KPIs falling outside of threshold ranges. These alerts can be configured to function in largely the same manner as the other alerts of the system. Such features of the disclosure provide substantial flexibility and customizability, enabling users to design a set of alerts that enhance the efficiency of operations of associated businesses.

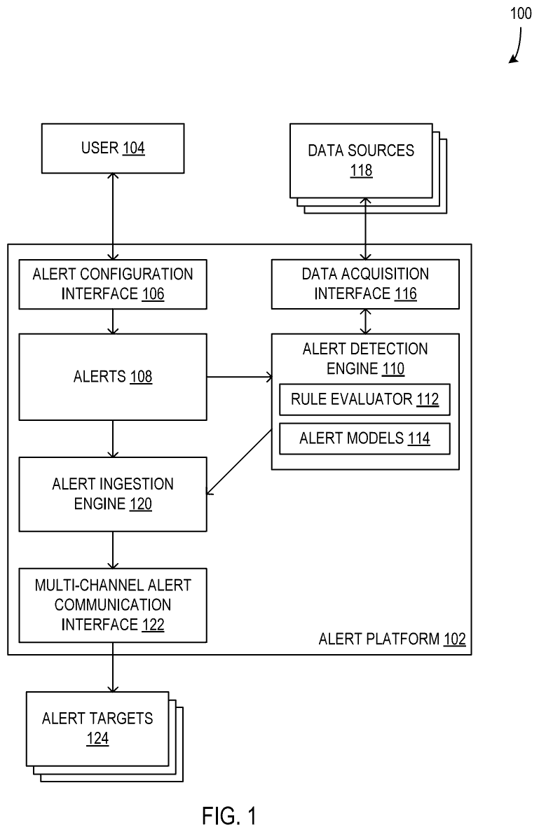

FIG. 1 is a block diagram illustrating a system 100 including an alert platform 102 configured for configuring alerts 108, detecting triggers of those alerts 108 using an alert detection engine 110, and sending alert notifications based on the detected triggers. In some examples, a user 104 is enabled by the alert platform 102 to create and/or configure an alert 108 using the alert configuration interface 106. An alert detection engine 110 is configured to use configured alerts 108 to access associated data on data sources 118 via data acquisition interface 116 and to detect triggered alerts 108 based on that accessed data. The alert detection engine 110 uses a rule evaluator 112 to evaluate rules of alerts 108 and/or trained alert models 114 associated with alerts 108. Upon detecting an alert trigger, the alert ingestion engine 120 is used to process alert-related data and that processed data is provided to the multi-channel alert communication interface 122, which is used to distribute alert information to alert targets 124 using one or more communication channels.

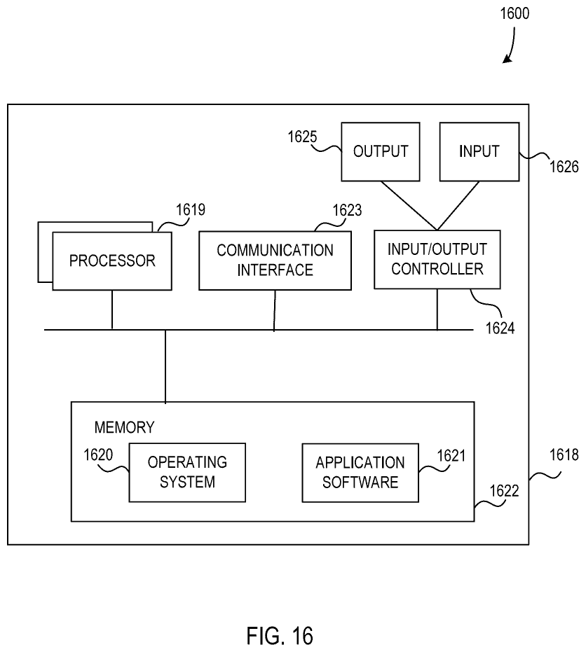

Further, in some examples, the system 100 includes one or more computing devices (e.g., the computing apparatus of FIG. 16) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the alert platform 102 is executed on a first computing device and a data source 118 is located on a second computing device within the system 100. The first computing device and second computing device are configured to communicate with each other via network connections. Alternatively, in some examples, other components of the alert platform 102 (e.g., alert detection engine 110 and alert ingestion engine 120) are executed on separate computing devices and those separate computing devices are configured to communicate with each other via network connections during the operation of the alert platform 102. In other examples, other organizations of computing devices are used to implement system 100 without departing from the description.

In some examples, users 104 are enabled to use the alert platform 102. Users 104 include customers that are configuring alerts for their business activities and/or users associated with the entity that operates the alert platform 102 for use in detecting anomalies during associated business activities. In other examples, other types of users 104 are enabled to use the alert platform 102 without departing from the description.

The alert platform 102 includes hardware, firmware, and/or software configured to interact with users using the alert configuration interface 106, to monitor alerts 108 using the alert detection engine 110, and to send alert-related notification and/or messages to alert targets 124 using the multi-channel alert communication interface 122. In some examples, the alert platform 102 is configured to enable alerts to be configured that use access to a wide variety of different data sources 118 and/or that communicate notifications using a wide variety of different communication channels to alert targets 124 as described herein. Further, in some examples, the alert platform 102 is configured to detect alert trigger states by evaluating rules using a rule evaluator 112 and/or by predicting or otherwise detecting the alert trigger states using trained alert models 114. The operations associated with processes performed by the alert platform 102 are described in greater detail below.

The alert configuration interface 106 includes hardware, firmware, and/or software configured to display or otherwise provide an interface to users 104 and to collect data from those users 104 during the process of configuring an alert 108. In some examples, the configuration of an alert 108 includes enabling a user 104 to enter text or other data associated with defined rules are used to evaluate wither the alert 108 is triggered or not. Additionally, or alternatively, the configuration of an alert 108 includes the creation, training, and/or configuration of an alert model 114 using machine learning techniques as described herein. Further, in some examples, the alert configuration interface 106 is configured to enable a user 104 to define and/or customize the data sources 118 from which data is obtained when evaluating the alert (e.g., defining a data path or address to the data source 118, providing credentials that enable the alert platform 102 to access the data source 118) and/or to define and/or customize the identities of the alert targets 124 and the communication channels by which those alert targets 124 are notified of the triggering of the alert 108.

In some examples, the alert configuration interface 106 includes or its operation is enabled by the use of a generative AI model for the creation of rules. In some such examples, a user 104 is enabled to enter a desired alert rule using plain language and the generative AI model analyzes the plain language and generates the desired alert rule in a format and/or syntax that enables the alert detection engine 110 to evaluate the rule.

Further, in some examples, the alert configuration interface 106 is enabled by aided model definition and/or design by engineers or other experts, such that a user 104 is enabled to describe the functionality of an alert model 114 to the alert platform 102 and/or associated experts and the alert platform 102 and/or associated experts then create the alert model 114 based on that description. In this way, users 104 are not necessarily required to be able to perform the complex task of creating a machine learning (ML) model to make use of this aspect of the alert platform 102.

In some examples, the alerts 108 of the alert platform 102 are data structures that store data in a format that enables the operations of the alert platform 102 as described herein. For instance, in an example, an alert 108 includes data that defines the rule or rules that are evaluated by the rule evaluator 112 of the alert detection engine 110, data defining method(s) by which the alert platform accesses data associated with the alert 108 from the data sources 118, and/or data indicating the alert targets 124 and channels by which notifications are sent in association with the alert 108. Further, in some examples, alerts 108 include data that defines what entities can interact with active instances of the alerts 108, such as a definition as to what users are enabled to close active alerts, snooze active alerts, or otherwise interact with active alerts. Additionally, or alternatively, in some examples, alerts 108 include data that indicates the type of information to be included in alert notifications, datetime data associated with when the alert was triggered and/or when an alert notification was sent, or the like. In other examples, more, fewer, or different types of data are included in the alerts 108 without departing from the description.

The alert detection engine 110 includes hardware, firmware and/or software configured for obtaining alert-related data from data sources 118 using the data acquisition interface 116, detecting alert trigger states using a rule evaluator 112 and/or alert models 114, and causing alert notifications to be sent to alert targets 124 based on the configurations of the associated alerts 108. In some examples, the alert detection engine 110 is configured to evaluate the rule(s) of an alert 108 periodically and/or based on the occurrence of a particular event. Further, the alert detection engine 110 is configured to access the alerts 108, determine defined methods of accessing associated data from data sources 118, and then using those determined methods to access the data via the data acquisition interface 116. Thus, the alerts 108 are configured to include defined data access information in a form that is compatible with the alert detection engine 110 and data acquisition interface 116. It should be understood that the alert platform 102 in general is configured to enable the interaction with a wide variety of different types of data sources 118 and, to achieve this flexibility, the processes involving the configuration of alerts 108 and the detection of alert instances based thereon are configured in such a way to enable the interaction with those different types of data sources 118.

The rule evaluator 112 is configured to access the requirements of a rule of an alert 108 and to apply those requirements to data value(s) obtained from the data sources 118 as described herein. In some examples, whether or not an evaluated rule is satisfied determines whether the associated alert is triggered. Alternatively, or additionally, some alerts 108 include multiple rules that are evaluated and the alerts 108 are triggered when at least one of the multiple rules is satisfied, when all the multiple rules are satisfied, or some other combination of the multiple rules are satisfied. It should be understood that the evaluation of one or more rules of an alert by the rule evaluator 112 can be performed in other ways without departing from the description.

In some examples, the alert models 114 are models that are trained using ML techniques. For instance, in an example, an alert model 114 is trained to receive data from data sources 118 as input and to generate a prediction of an alert trigger based on that received data. In some such examples, the alert models 114 generate output that indicates a likelihood that an alert should be triggered and/or output that describes the type of alert that should be triggered and/or other types of data associated with alerts to be triggered, such as parameters or features of alerts.

In some examples, the alert models 114 are trained using historical data and/or generated training data that is similar to the type of data that will be provided to the alert models 114 during operation of the system 100. Further, in some examples, during operation of the system 100, feedback is provided by users who receive alerts (e.g., alert targets 124) and that feedback can be used to further fine-tune the alert models 114. For instance, in an example, an alert is sent to an alert target 124 based on output generated by an alert model 114 and the alert target 124 finds the alert to be unnecessary or otherwise inaccurate. The alert target 124 provides feedback to the system 100 indicating that the alert was inaccurate, and that feedback is then used to adjust the weights or other aspects of the alert model 114 to improve its accuracy during future operations.

The alert ingestion engine 120 includes hardware, firmware, and/or software configured to receive alerts 108 to be sent associated with output of the alert detection engine 110. The alert ingestion engine 120 is configured to perform some pre-processing operations on alerts 108 to prepare them to be sent and/or to perform processing to determine whether the alerts 108 are to be sent. For instance, in an example, the alert ingestion engine 120 tracks alerts that have been sent over a past period of time and performs de-duplication operations on alerts 108 that come in, such that many instances of the same alert 108 are not sent, flooding the inboxes of alert targets 124. Alternatively, or additionally, the alert ingestion engine 120 is configured to use alert information to obtain additional data from databases or data lakes to enhance the alert message that will be sent with respect to that alert. For instance, in an example, the alert detection engine 110 indicates to the alert ingestion engine 120 that an alert 108 associated with a particular alert ID should be sent, but the alert detection engine 110 is not configured to send all data associated with that alert 108. So, the alert ingestion engine 120 is configured to ingest additional alert information associated with the alert ID in order to generate a complete alert message associated with the alert 108.

The multi-channel alert communication interface 122 includes hardware, firmware, and/or software configured to enable alert messages generated by the alert ingestion engine 120 to be sent to a wide variety of alert targets 124 using a wide variety of different communication channels. In some examples, the multi-channel alert communication interface 122 enables alert messages to be sent to alert targets 124 using email, JIRA, specific APIs, dedicated alert messaging platforms, Kafka or other data stream platforms, or the like. Further, in some examples, the multi-channel alert communication interface 122 is configured to enable alert messages to be sent instantaneously upon an alert trigger being detected, on a defined schedule, and/or in an alert digest message including multiple different alerts that have occurred. In other examples, other types of communication channels are used by the multi-channel alert communication interface 122 without departing from the description.

In some examples, the alert targets 124 include users that are being notified of alert triggers by alert messages as described herein. Additionally, or alternatively, the alert targets 124 include other computing systems that are configured to receive the alert messages and log them and/or perform some other operations based on receiving the alert messages. It should be understood that, in some examples, the alert platform 102 is configured to send alert messages to a wide variety of different alert targets 124 using different communication channels without departing from the description.

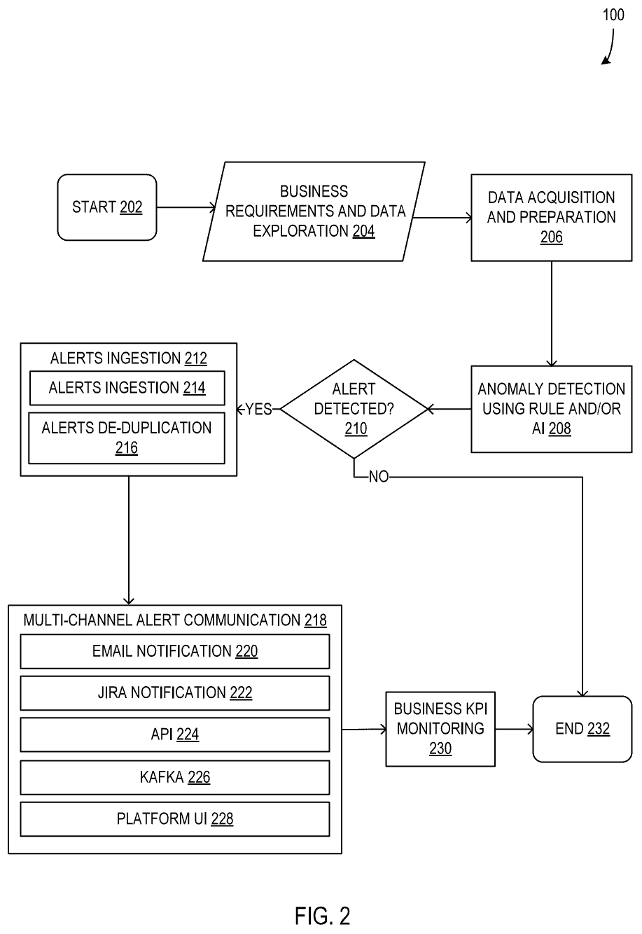

FIG. 2 is a flowchart illustrating example processes performed by and/or in association with a system such as system 100 of FIG. 1. At 202, the process begins and, at 204, business requirements and associated data are explored by users or other entities that plan to use the system. In some examples, this step includes determining the types of events or system states that should trigger alarms and then determining the types of data and associated data values that should be the triggers of those alarms.

At 206, data is acquired and prepared. In some examples, the operations of 206 are performed by an alert platform 102 using a data acquisition interface 116 as described herein. Data that is obtained is also prepared for consumption in some examples, such as converting the format of the obtained data so that it is compatible with an alert model 114.

At 208, anomalies are detected using rules and/or AI (e.g., alert models 114). This is performed in substantially the same way as previously described. At 210, if an alert is detected, the process proceeds to 212. Alternatively, if an alert is not detected, the process proceeds to end at 232.

At 212, ingestion processes are performed on the detected alert, as described above with respect to the alert ingestion engine 120. In some examples, the ingestion processes include ingestion 214 of additional data associated with the alert and de-duplication 216 of the alert as described herein.

At 218, the alert is sent to alert targets 124 using multi-channel alert communication, such as email notification 220, Jira notification 222, APIs 224, Kafka 226 and/or other data streaming platforms, and/or a dedicated platform UI 228. Further, the sent alert is used during business KPI monitoring 230. The process then ends at 232. It should be understood that, in other examples, the process continues to detect anomalies and perform the various operations described herein.

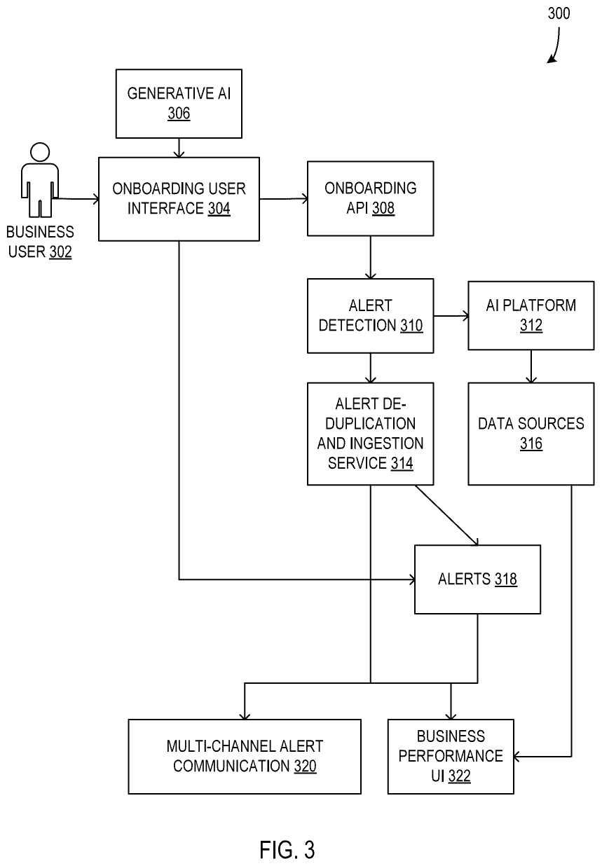

FIG. 3 is a flowchart 300 illustrating example processes for rule-based anomaly detection in a system such as system 100 of FIG. 1. A business user 302 is enabled to use an onboarding UI 304 and an associated onboarding API 308 to generate a rule that causes an alert to be triggered. The business user 302 is enabled to draft the text and/or code of the rule themselves and/or they are enabled to draft the rule with the help of a generative AI 306 that is configured to transform plain language rule descriptions into the code or other text needed for the rule to be evaluated at alert detection 310.

Onboarded alerts 318 are used during alert detection at 310 and, when an alert 318 is detected, the alert de-duplication and ingestion service 314 processes the alert before an associated message is sent out via multi-channel alert communication 320. In some examples, this process is substantially similar to the operations of the alert detection engine 110, the alert ingestion engine 120, and the multi-channel alert communication interface 122 of system 100 described above.

Further, in some examples, alerts detection uses an AI platform 312 and associated data sources 316. This logged alert data is used to provide information about the operations of the business via a business performance UI 322.

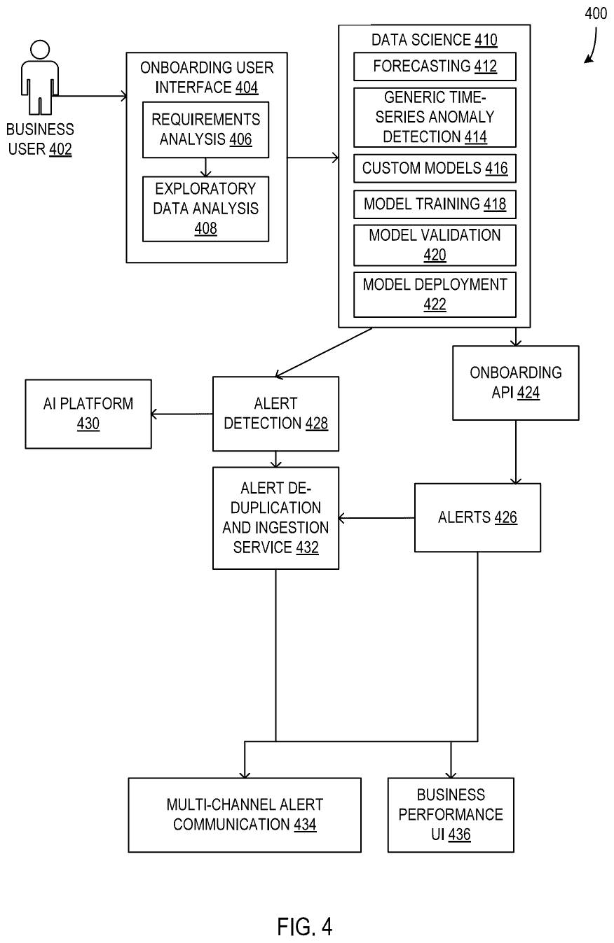

FIG. 4 is a flowchart 400 illustrating example processes for machine learning-based anomaly detection and prediction in a system such as system 100 of FIG. 1. A business user 402 is enabled to use an onboarding UI 404 to provide requirements and/or other model information that enables the processes of flowchart 400 to use ML models to predict and/or detect anomalies in the operations of an associated system. In some examples, the onboarding UI 404 further enables the use of requirements analysis 406 and/or exploratory data analysis 408 (e.g., by experts in the creation of ML models) to generate models that are used for the described tasks.

Further, in some examples, the system and associated processes make use of data science 410 techniques, including the generation of models that are trained in forecasting 412 events or system states using ML, models that are trained in time-series anomaly detection 414, and/or other custom models 416. The data science techniques include model training processes 418, model validation 420 that validates that training of the models is complete, and model deployment 422 that deploys validated models for use in performing the described prediction and/or detection tasks based on input datasets (e.g., data from data sources 118 of FIG. 1).

In some examples, an onboarding API 424 is configured to deploy trained models for use in triggering one or more alerts 426 during an alert detection 428 process. When a trained model triggers an alert 426 during alert detection 428, the alert de-duplication and ingestion service 432 performs de-duplication and/or ingestion processes on the triggered alert 426 as described herein.

In some examples, the alert detection 428 process uses an AI platform 430.

Further, in some examples, onboarded alerts 426 are used during alert detection at 428 and, when an alert 426 is detected, the alert de-duplication and ingestion service 432 processes the alert before an associated message is sent out via multi-channel alert communication 434. In some examples, this process is substantially similar to the operations of the alert detection engine 110, the alert ingestion engine 120, and the multi-channel alert communication interface 122 of system 100 described above.

Further, in some examples, detected alerts are logged and this logged alert data is used to provide information about the operations of the business via a business performance UI 436 as described herein.

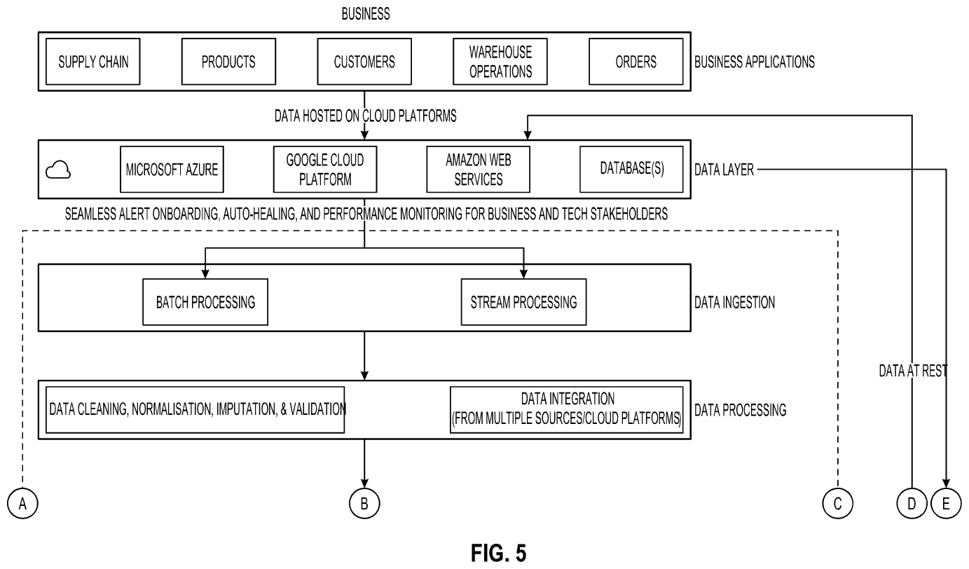

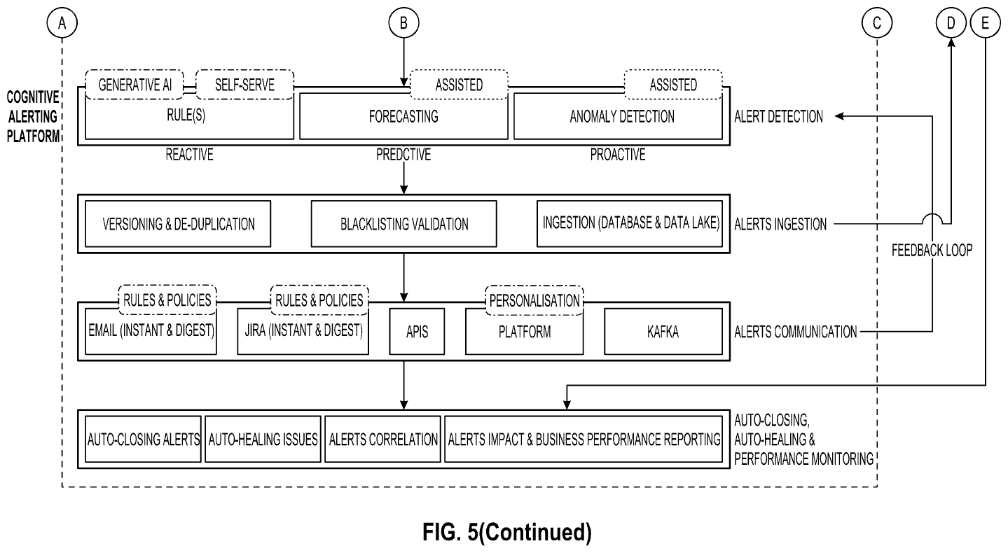

FIG. 5 is another diagram illustrating a system and associated methods for predicting and/or detecting anomalies using business data as described herein. At the top, a row of example business applications to which the described systems and methods can be applied are labeled. In some examples, such business applications include supply chain applications, product-based applications, customer-based applications, warehouse operations, orders-based applications, or the like. Data from the business applications is hosted and/or stored in the illustrated data layer.

In some examples, the data layer includes databases, cloud data storage, and/or other types of data stores. For instance, in some examples, the data layer includes MICROSOFT AZURE cloud storage, GOOGLE CLOUD PLATFORM cloud storage, AMAZON WEB SERVICES cloud storage, and/or other databases.

In some examples, the Cognitive Alerting Platform (e.g., the alert platform 102 of FIG. 1) ingests data from the data layer using data ingestion techniques. For instance, in some examples, data is ingested using batch processing techniques and/or stream processing techniques.

Further, in some examples, the Cognitive Alerting platform processes the ingested data to make it ready for use in alert detection processes as described herein. For instance, in some examples, the data processing includes data cleaning, normalization, imputation, and/or validation tasks. Further, in some such examples, the data processing includes integration of data from multiple sources into combined data sets that are compatible with the alert detection processes of the platform.

As described herein, in some examples, the Cognitive Alerting Platform detects alerts using one or more rules-based techniques and/or model-based techniques. For instance, in some examples, the platform detects alerts using rules that have been created to meet the requirements of users as described herein (e.g., via enabling users to design their own rules and/or work with a generative AI to generate rules). Further, in some examples, models are used to forecast alert-triggering events or states and/or models are used to proactively detect anomalies as described herein.

Additionally, in some examples, the Cognitive Alerting Platform ingests alerts that are triggered. In some such examples, the ingestion includes versioning and/or de-duplication of alerts, blacklisting validation of alerts, and/or ingestion of the alerts and/or associated data to a database or data lake (e.g., ingestion of alert data to the data layer described above).

In some examples, the Cognitive Alerting Platform distributes and/or sends information associated with ingested alerts to alert targets (e.g., alert targets 124) using one or more different communication channels. For instance, in some examples, alert information is sent to targets via email in instant and/or digest form, via JIRA in instant and/or digest form, via APIs and/or custom platforms, and/or via streaming platforms such as KAFKA. Additionally, or alternatively, in some examples, after sending alert information associated with an alert, an indication is sent back to the alert detection process in the form of a feedback loop that prevents information associated with that alert and/or similar alerts from being sent again for a period of time (e.g., blacklisting the alert).

Further, in some examples, the Cognitive Alerting Platform is configured to perform other alert management operations, such as automatically closing alerts based on rules or settings, automatically healing issues that arise, correlation of alerts to provide additional information about the states of associated systems and/or events therein, and/or reporting associated with alerts impact and/or business performance related thereto.

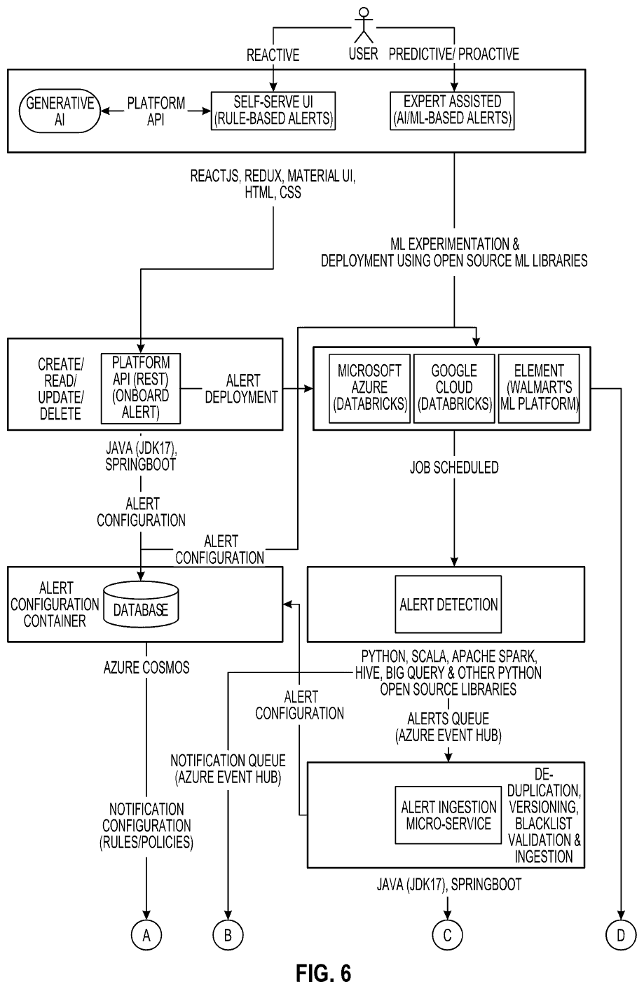

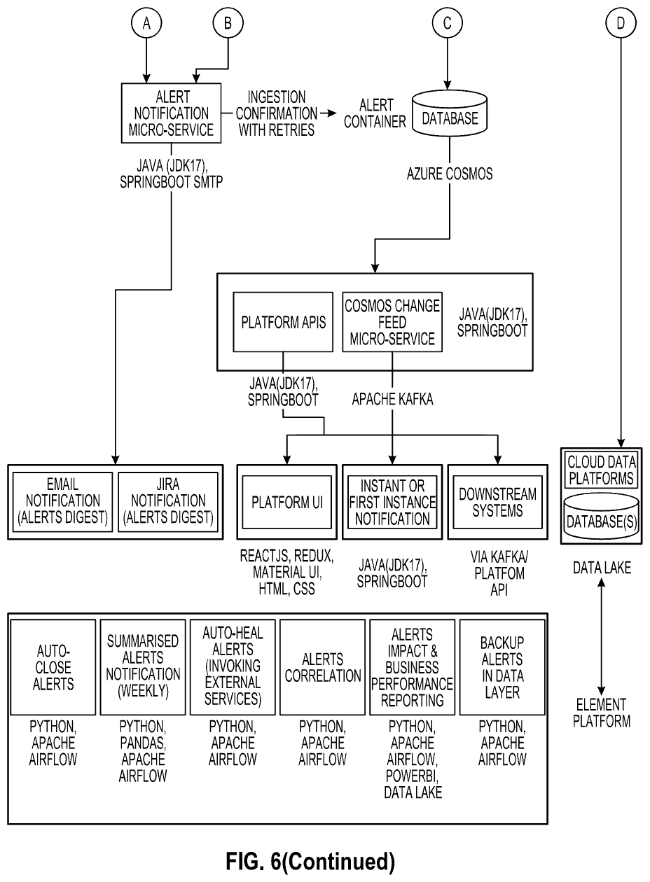

FIG. 6 is another diagram illustrating a system and associated methods for predicting and/or detecting anomalies using business data as described herein. At the top of the diagram, a user generates alerts for the system. In some examples, the user uses a self-serve UI and/or a generative AI to generate rules-based alerts (e.g., as described above with respect at least to FIGS. 1 and 3). Additionally, or alternatively, the user uses expert assistance to generate models that predict and/or detect anomalies and trigger alerts (e.g., as described above with respect at least to FIGS. 1 and 4).

Further, in some examples, the described platform includes a platform API for onboarding at least rules-based alerts (e.g., alert configuration interface 106 and/or onboarding API 308) and/or deploying alerts to a data layer and/or a database of alert configuration containers.

In some examples, the data layer includes one or more of MICROSOFT AZURE databricks, GOOGLE CLOUD databricks, an Element platform, or other data store.

In some examples, jobs associated with deployed alerts are scheduled as part of an alert detection process and, when an alert is triggered, it is queued for ingestion by an alert ingestion micro-service as described herein.

Additionally, or alternatively, the platform includes an alert notification micro-service that sends notification associated with detected alerts to alert targets via email and/or JIRA as described herein. Further, in some such examples, the platform includes an alerts container database from which triggered alerts are provided to platform APIs and or a change feed micro-service, enabling alert notifications to be sent to alert targets using a wide variety of different communication channels (e.g., platform UIs, instant or first instance notifications, downstream systems).

Further, in some examples, the platform includes additional alert management and/or processing features as described above, such as automatic closing of alerts, summarized alerts (e.g., weekly alert digests), automatic healing of alerts, correlation of alerts, reporting of alerts impact and associated business performance, and/or backup alerts in the data layer.

In some examples, the alert configuration of an alert includes information about the alert, such as the owner of the alert, a query associated with the trigger of the alert, the cloud platform where the alert is to be onboarded, the alert organization structure, any co-owners of the alert, targets of alert notifications, or the like.

In some examples, an alert is automatically closed by a platform when the alert has not recurred or otherwise been detected during a defined time interval (e.g., a 24-hour interval).

In some examples, an alert is automatically resolved, or auto healed, through an interaction with an application which is configured to automatically perform an action to address the event or state that triggered the alert.

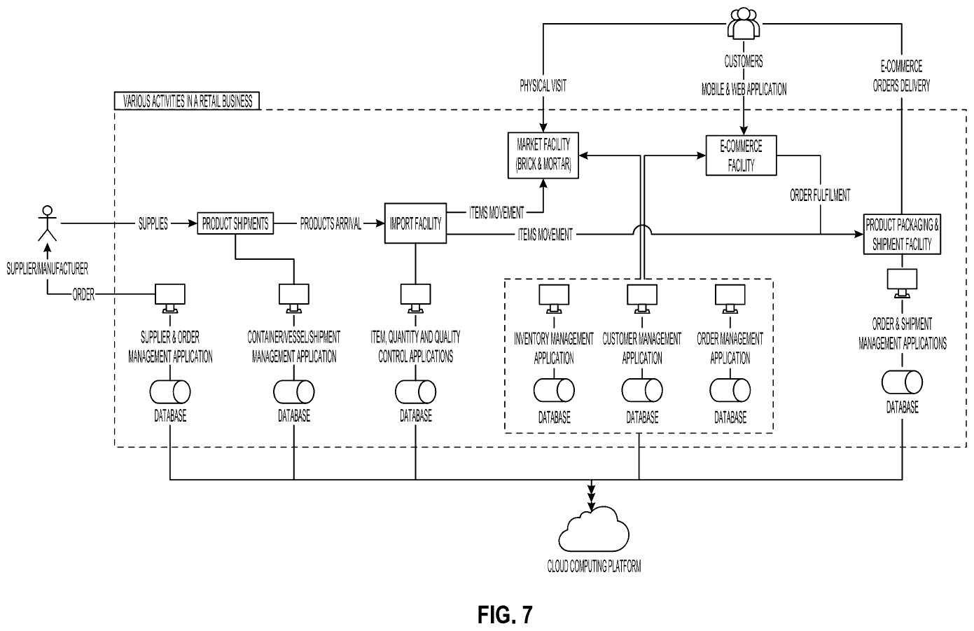

FIG. 7 is a diagram illustrating examples of various activities of a retail business and the types of applications and data used by such a business. In some examples, the retail business uses the described systems and methods to monitor business data, detect anomalies therein, and send users of the retail business alerts based on the detected anomalies, as described herein.

Data is critical to the growth and smooth functioning of any business today, especially in a retail business where markets are extremely competitive. FIG. 7 is an example to demonstrate some of the activities of a retail business. The list of activities and applications that are used to manage the business activities is dependent on the business and virtually inexhaustible. The type of products, suppliers, manufacturers, imports, packaging, e-commerce setup, shipments, etc. define the set of business applications that are needed. For example, a business that sells groceries is different from businesses that sell toys, medicines, tires, electronics, etc. Thus, the applications required to manage the business are likely to also be different. However, the data captured by various applications at different stages in the business plays an important role in business growth and customer satisfaction.

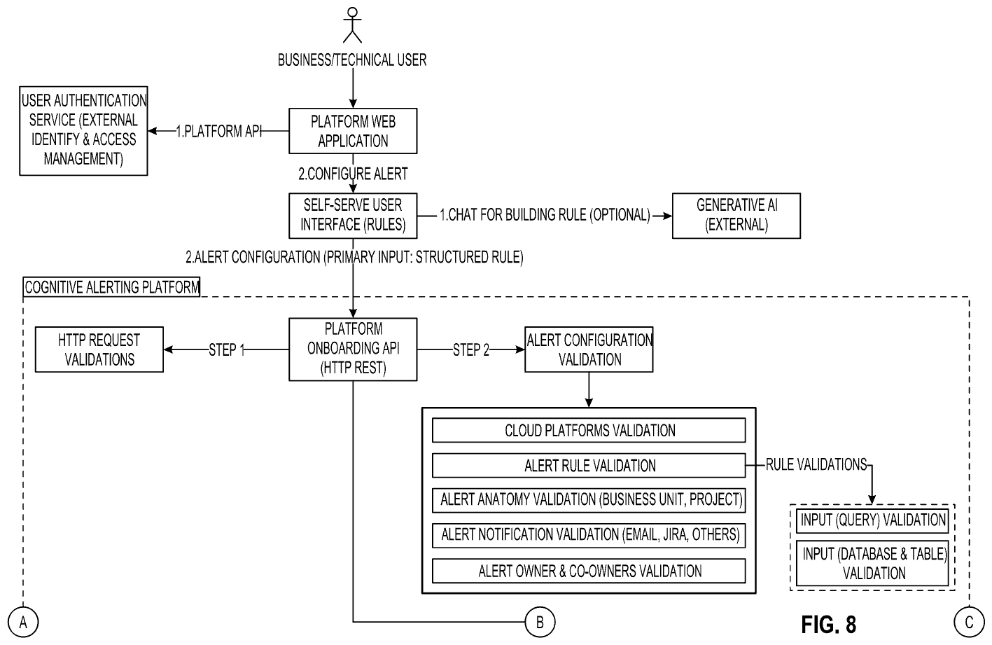

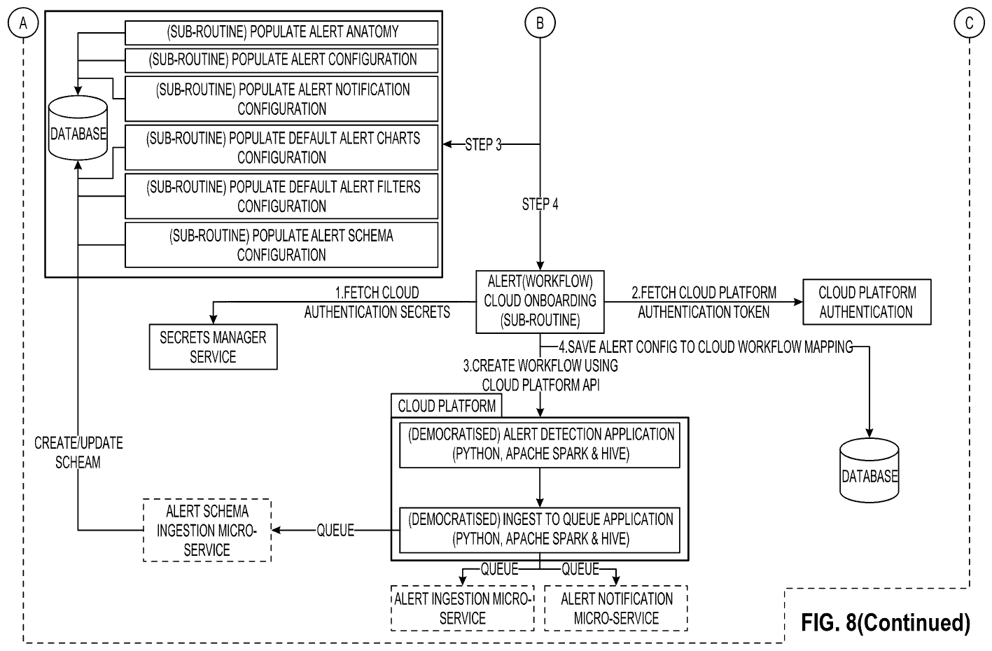

FIG. 8 is a diagram illustrating a detailed process for onboarding and detecting rules-based alerts as described herein. In some examples, the platform of FIG. 8 is configured to operate in the same way as described above in FIG. 3. Further, in some examples, the process includes a platform web application that enables a user to access the system. The platform web application uses a user authentication service to authenticate the user (e.g., based on external identity and/or access management). The user is then enabled to configure an alert using the self-serve user interface for rules-based alert building. As described herein, in some examples, the user works with a generative AI to build and/or configure an alert.

In some examples, the alert configuration information is provided to the Cognitive Alerting Platform (e.g., alert platform 102 of FIG. 1) via a platform onboarding API. In some such examples, HTTP requests associated with the onboarding are validated and the alert configuration information is also validated.

In some examples, the alert configuration validation includes cloud platform validation, alert rule validation (e.g., input (query) validation and/or input (database and table) validation), alert anatomy validation (e.g., based on business unit and/or project association), alert notification validation (e.g., based on communication channels used by the alert for notification such as email, JIRA, and/or others as described herein), and/or alert owner and/or co-owner validation. Each of these validations confirms the accuracy, feasibility, and/or compatibility of aspects of the alert configuration information. For instance, in an example, an alert notification process includes confirming that the alert configuration information is sufficient for the platform to access the communication channels described by the alert notification information in the configuration. In other examples, more, fewer, or different types of validations are performed on the alert configuration information without departing from the description.

In some examples, the alert configuration information is used to populate an alert database or other similar data store with the alert. This alert population process includes subroutines such as populating the alert anatomy, populating the alert configuration, populating the alert notification configuration, populating the default alert charts configuration, populating the default alert filters configuration, and/or populating the alert schema configuration. In some examples, each of these subroutines is used to build out the data structure and associated data parameters, variables, and/or entries in the data structure of the alert with which the alert configuration information is associated. For instance, in an example, the populate alert notification configuration subroutine writes the alert notification configuration data structure and associated information to the alert database such that it can be used later to send notifications associated with the alert.

Further, in some examples, the process includes an alert workflow cloud onboarding subroutine, during which cloud authentication secrets and cloud platform authentication tokens are fetched that are needed for use with the alert. The associated alert workflow is created on a cloud platform and the alert configuration is saved to a cloud workflow mapping database.

In some examples, the cloud platform performs the alert workflow using an alert detection application and, when alerts are detected, the alerts are ingested in an alert queue application. Based on its position in the queue, the detected alert is sent to the alert ingestion micro-service and/or the alert notification micro-service.

Further, in some examples, the detected alert is sent to an alert schema ingestion micro-service through which a schema associated with the alert can be created or updated in the alert configuration database/data store.

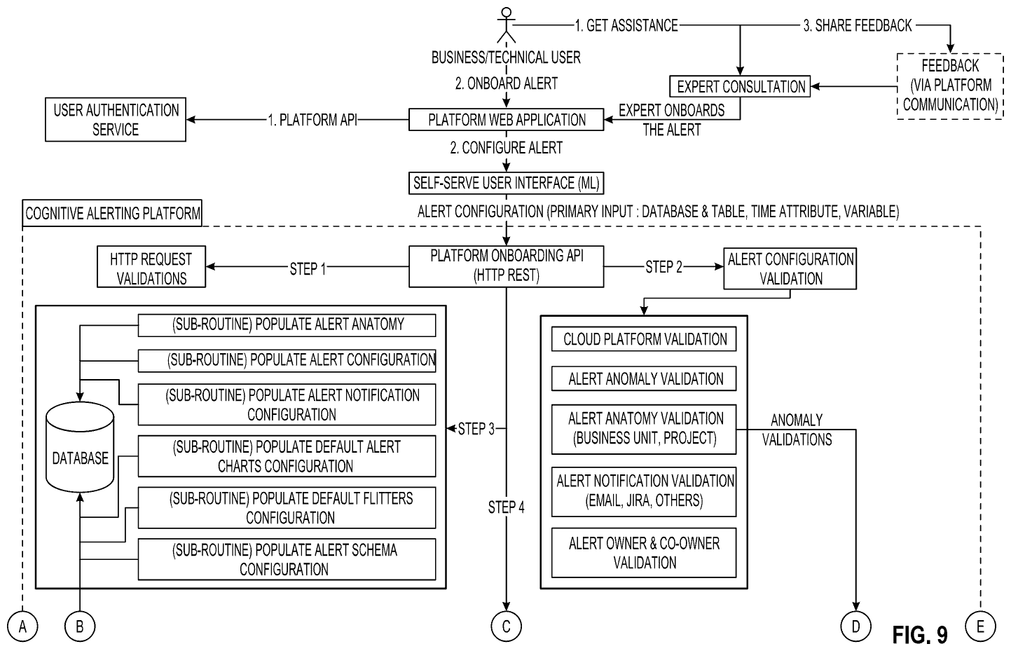

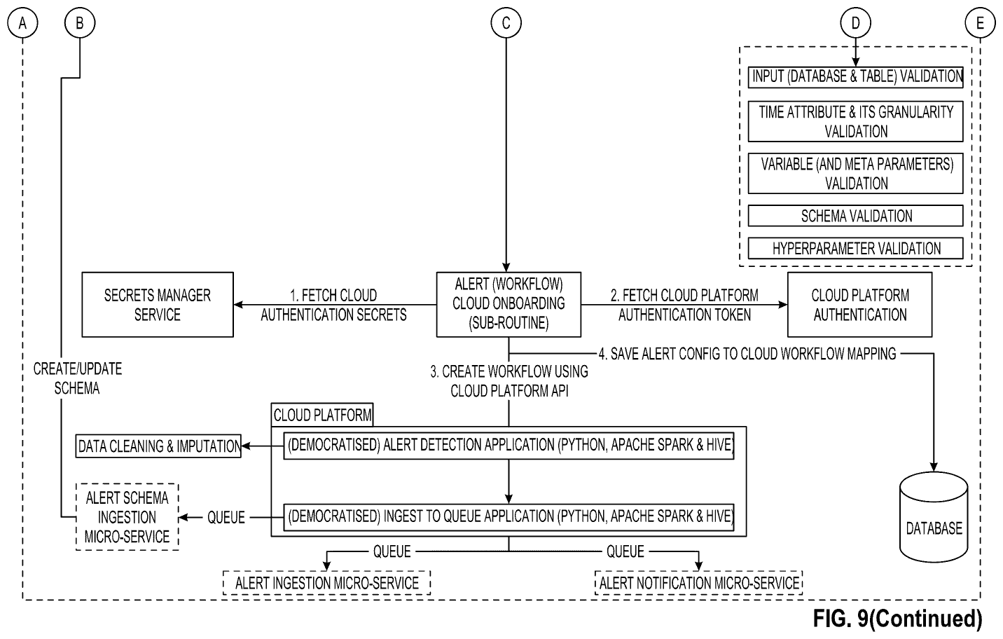

FIG. 9 is a diagram illustrating a detailed process of onboarding and detecting machine learning driven alerts associated univariate anomaly detection models as described herein. In some examples, the platform of FIG. 9 is configured to operate in the same way as FIG. 4. Additionally, or alternatively, the platform of FIG. 9 is configured to operate in substantially the same way as FIG. 8, above. Further, in some examples, the user is initially aided by an expert consultation in order to determine what sort of ML model will be used to detect a triggering event or state of the user's alert. The user interacts with the expert consultation, including the sharing of feedback via a communication platform, and the user and/or experts onboard the alert information to the platform web application.

Further, in some examples, the platform includes, as part of the alert configuration validation process, subprocesses to validate alert anomalies, including database and table validation, time attribute and associated granularity validation, variable and meta parameter validation, schema validation, and/or hyperparameter validation.

Additionally, or alternatively, in some examples, the alert workflow that is created on the cloud platform associated with the ML model-based alert includes the use of that ML model during the alert detection application process. In some such examples, the alert detection process includes data cleaning and imputation steps associated with the ML model of the alert.

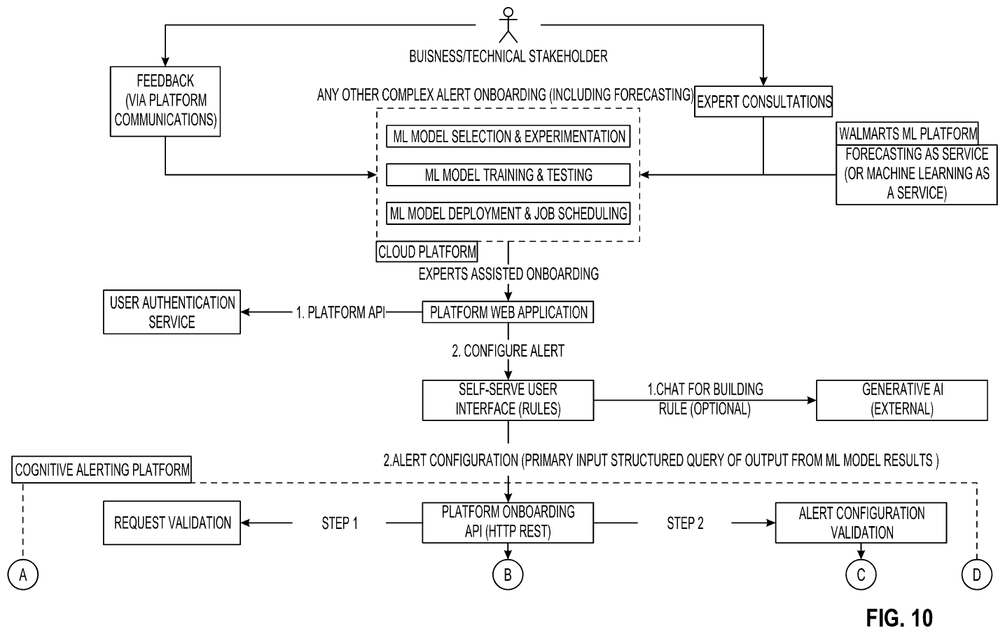

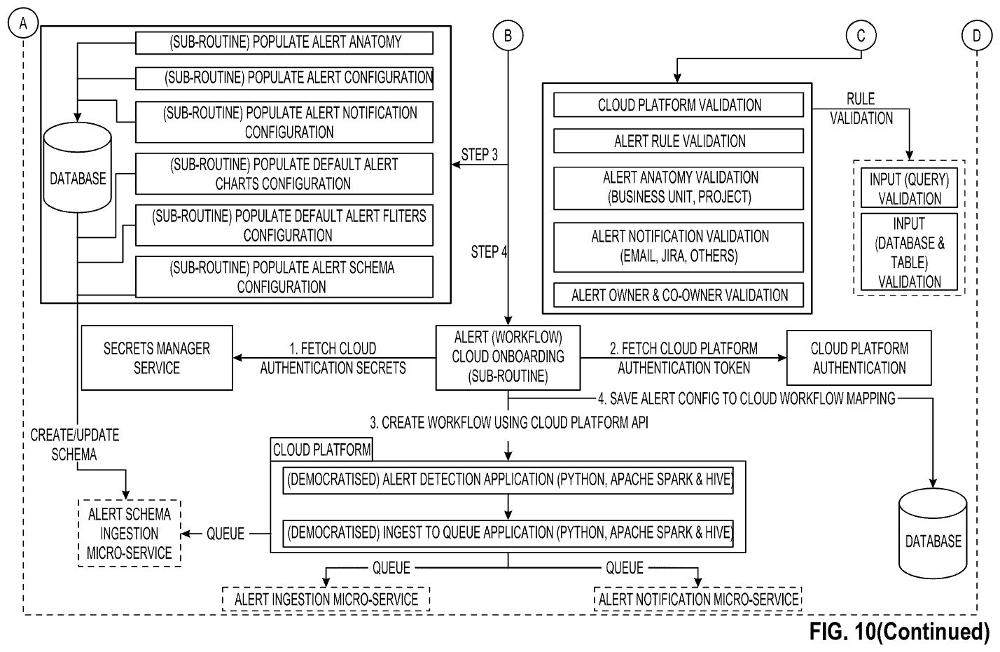

FIG. 10 is a diagram illustrating a detailed process for onboarding and detecting machine learning-based alerts associated with forecasting and/or custom ML models as described herein. In some examples, the platform of FIG. 10 is configured to operate in substantially the same way as described above with respect to FIGS. 4, 8, and 9. Further, in some examples, the user and expert consultation work together to create an ML model using ML techniques such as ML model selection and experimentation, ML model training and testing, and ML model deployment and job scheduling. Once the ML model for use with the alert is complete, the associated alert configuration information is provided to the Cognitive Alerting Platform as described above.

Further, it should be understood that the created ML model is then used by the cloud platform as part of the workflow of the alert, such that data is provided as input to the ML model and the output of the ML model is evaluated to determine whether the alert has been triggered and/or other details or features of a triggered alert. Thus, in some examples, except for the use of the custom model that is trained at the beginning of the process, the handling of the alert information is substantially the same as in the other processes of at least FIGS. 8 and 9 as described above.

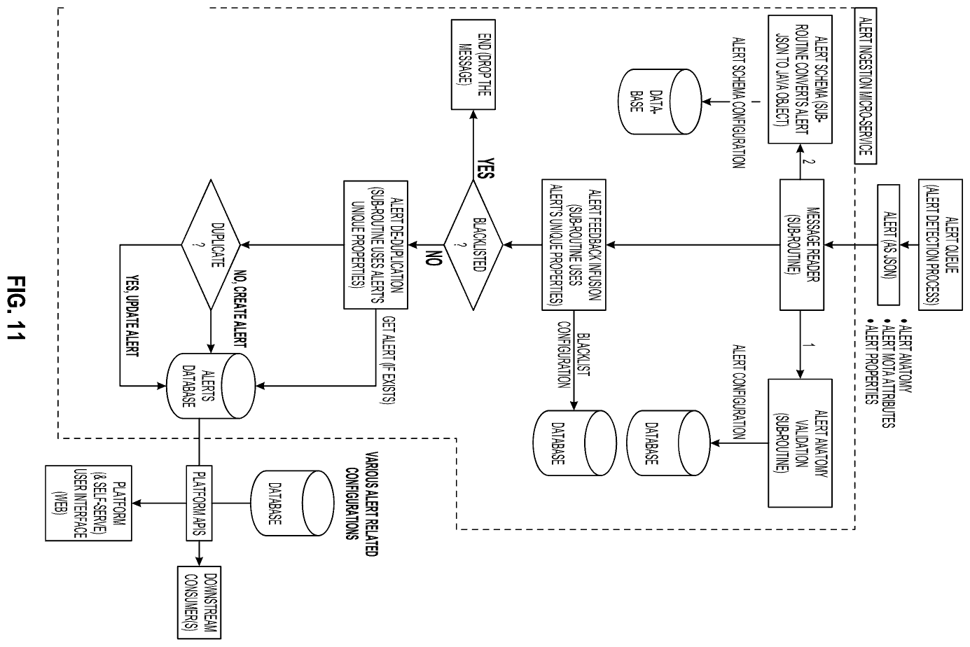

FIG. 11 is a diagram illustrating a process performed by an alert ingestion micro-service. In some examples, the process of the alert ingestion micro-service is performed as part of the operation of a system such as the platforms of FIGS. 8, 9, and 10 described above.

An alerts queue provides an alert to the alert ingestion micro-service, wherein the alert includes alert anatomy, alert meta-attributes, and alert properties. The alert is read and validated by the micro-service. The micro-service determines whether the alert has been blacklisted (e.g., users do not want to be notified of the alert during the current time period), and if it has been blacklisted, the alert is dropped, and the micro-service ends the processing of that alert. However, if the alert is not blacklisted, the micro-service determines if the alert is a duplicate alert (e.g., an alert for which notifications have already been sent within a recent time period). If the alert is not a duplicate, the alert is created in an alerts database. Alternatively, if the alert is a duplicate, the alert is updated with the most recent information in the alerts database. The alerts database is used by platform APIs and/or other entities of the system to send notifications about alerts or otherwise use the alert information as described herein (e.g., alert information sent to other databases, downstream consumers of alert information, and/or platform and self-serve user interfaces).

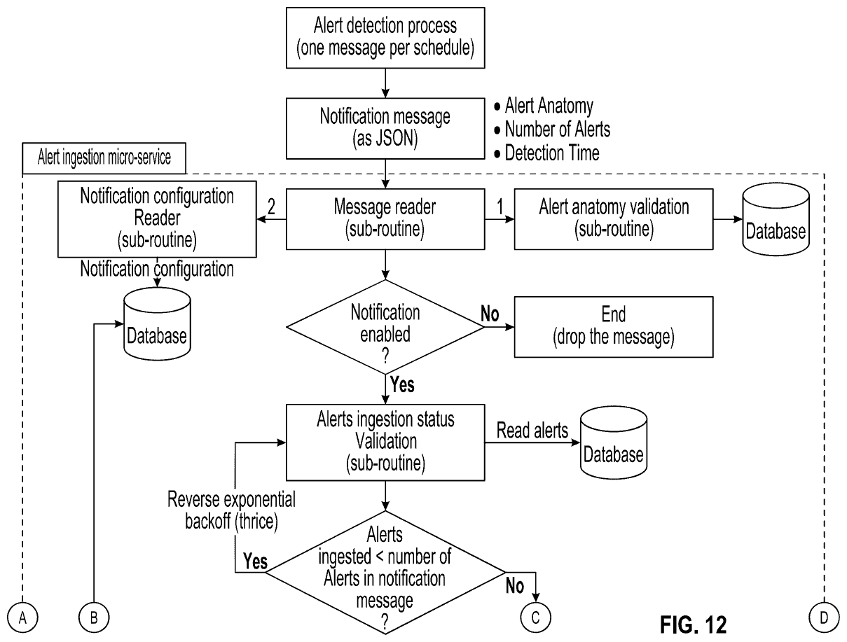

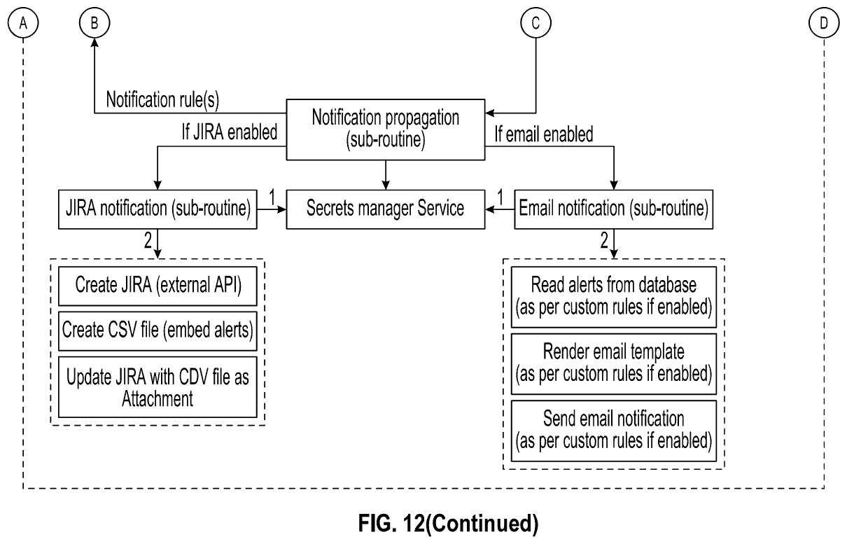

FIG. 12 is a diagram illustrating a process performed by an alert notification micro-service. In some examples, the process of the alert notification micro-service is performed as part of the operation of a system such as the platforms of FIGS. 8, 9, and 10 described above.

A notification message associated with an alert is received from the alert detection process by the alert notification micro-service. The micro-service performs validation of the alert information (e.g., the alert anatomy) and obtains the notification configuration associated with the received alert from a notification configuration database. If notification is not enabled for this alert, the alert is dropped, and the alert notification micro-service ends the processing of this alert. Alternatively, if notifications are enabled for the alert, an alert ingestion status validation subroutine is performed.

The alerts ingestion status validation subroutine reads alerts from an alerts database to validate the ingestion status of those alerts. If the alerts ingested are less than the number of alerts in the received notification message, the alerts ingestion status validation subroutine continues. Alternatively, the notification propagation subroutine gets notification rule(s) associated with the ingested alerts from a notification configuration database and proceeds to propagate the notifications as described in the notification configurations of the alerts.

If email and/or JIRA are enabled as notification communication channels, the secrets manager service is used to determine secret information necessary to use those communication channels, then the email notification subroutine and/or the JIRA notification subroutine proceed to use those communication channels to send information about the alerts of the received message. For instance, for JIRA, JIRA is created, a CSV file is created, and the JIRA is updated with the CSV file as an attachment. In another example, for email, the alerts are read from a database, rendered as an email template, and sent via email to one or more alert targets, whereby the emails are dependent on custom rules if enabled for those alerts.

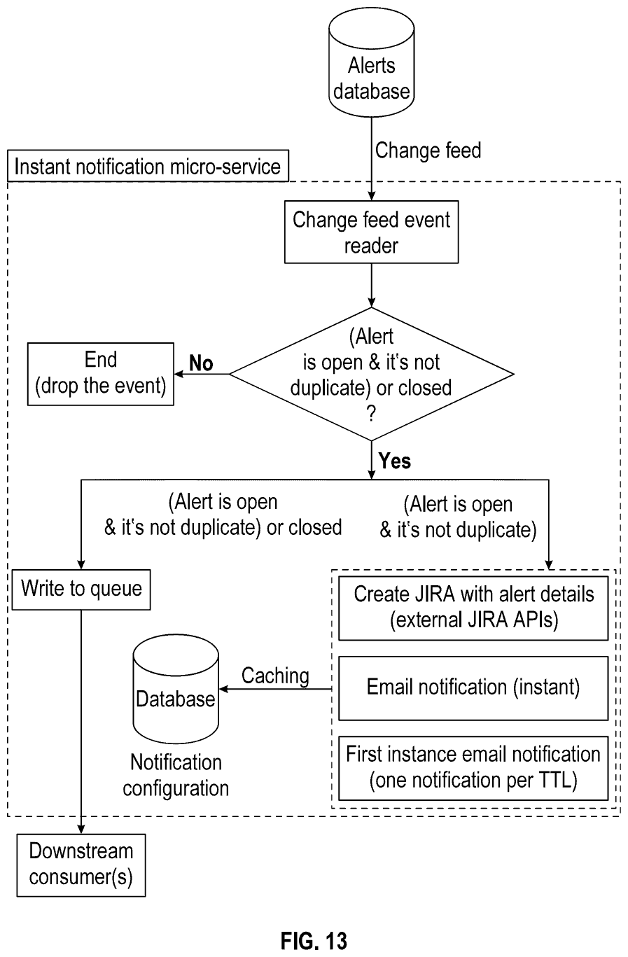

FIG. 13 is a diagram illustrating a process performed by a real-time alert notification micro-service. In some examples, the process of the real-time alert notification micro-service is performed as part of the operation of a system such as the platforms of FIGS. 8, 9, and 10 described above.

A change feed event reader of the micro-service obtains a change feed from an alerts database. If a change feed event does not include either an open alert that is not a duplicate or a closed alert, the process drops that event. Alternatively, if the change feed event includes either an open alert that is not a duplicate or a closed alert, the process proceeds.

If the change feed event includes an alert that is open and not a duplicate or a closed event, the event is written to a queue that is provided to downstream consumers of the alert event information. For instance, in some examples, another entity is using open alert events and closed alert events to perform some other operations.

Further, in some examples, if the change feed event includes an open alert that is not a duplicate, a JIRA is created with the alert details, an email notification is generated, and/or a first instance email notification is generated. The generated information is cached in the notification configuration database.

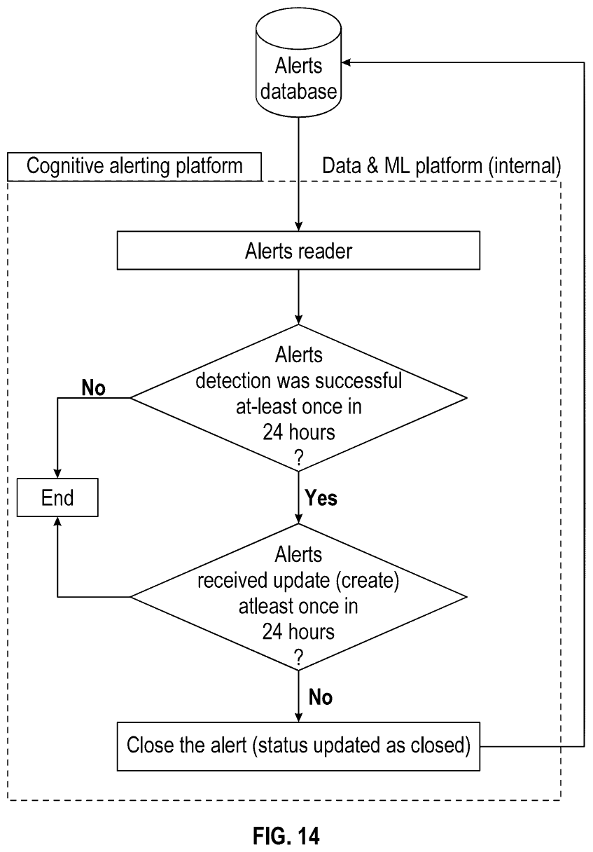

FIG. 14 is a diagram illustrating a process for automatically closing alerts. In some examples, the process for automatically closing alerts is performed as part of the operation of a system such as the platforms of FIGS. 8, 9, and 10 described above.

An alerts reader reads alerts from an alerts database. If an alert detection for an alert was not successful at least once in a defined time period (e.g., 24 hours), the process ends. If an alert detection for the alert was successful at least once within the defined time period, the process proceeds.

If the alert was created or received an update at least once within a defined time period (e.g., 24 hours), the process ends. If the alert has not been created or received an update at least once within the defined time period, the process proceeds to close the alert, updating the status of the alert to be closed. The process then returns to read another alert from the alert database. Thus, alerts that have become stale based on the defined time periods are automatically closed. In other examples, other types of data are evaluated when determining whether to automatically close an alert without departing from the description.

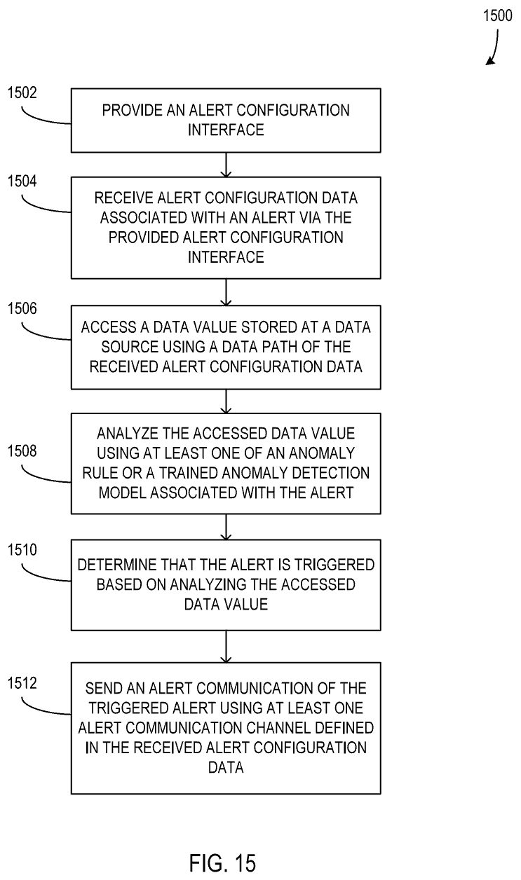

FIG. 15 is a flowchart illustrating a method 1500 for onboarding an alert and detecting an anomaly based on the onboarded alert. In some examples, the method 1500 is executed or otherwise performed in a system such as system 100 of FIG. 1. In some examples, the method 1500 is performed as part of the operation of a system such as the platforms of FIGS. 1, 8, 9, and 10 described above.

At 1502, an alert configuration interface is provided. In some examples, the alert configuration interface is the alert configuration interface 106 as described above.

At 1504, alert configuration data associated with an alert is received via the provided alert configuration interface.

At 1506, a data value stored at a data source is accessed using a data path of the received alert configuration data. In some examples, the alert configuration data defines the alert as an alert 108 as described above and the data value is accessed from a data source 118 via the data acquisition interface 116 as described above.

At 1508, the accessed data value is analyzed using at least one of an anomaly rule or a trained anomaly detection model associated with the alert. In some examples, the alert is either a rules-based alert or a model-based alert as described herein.

At 1510, it is determined that the alert is triggered based on analyzing the data value. In some examples, the data value causes the anomaly rule to be satisfied, indicating the triggering of the alert. Alternatively, in some examples, the data value is provided to a model as input and the model output indicates that the alert is triggered.

At 1512, an alert communication of the triggered alert is sent using at least one alert communication channel defined in the received alert communication data. In some examples, the alert communication is sent to one or more alert targets 124 using an email channel, a JIRA channel, an API-based channel, a data streaming platform channel, and/or another platform interface channel.

An example alert configuration structure is provided below.

{
“id”: “12b30ebd-6964-40db-b515-8d7186386b16”,
“functionalAreaId”: “656c68da-251c-44dc-a20a-e01a9d8fd46a”,
“projectId”: “ebb9bd13-e4c1-41f1-b385-0563275583a5”,
“name”: “Items Out of Stock”,
“description”: “Alert when item is out of stock”,
“condition”: “select * from items where qty=0”,
“frequency”: “0 30 13 * * ? * ”,
“enabled”: true,
“autoCloseEnabled”: true,
“uniqueProperties”: [
“dept_nbr”,
“item_nbr”
],
“displayColumns”: [
{
“name”: “properties.item_nbr”,
“alias”: “Item#”
},
{
“name”: “properties.item_desc”,
“alias”: “Item description”
},
{
“name”: “properties.dept_nbr”,
“alias”: “Dept#”
},
{
“name”: “properties.dept_desc”,
“alias”: “Dept description”
},
{
“name”: “status”,
“alias”: “Alert Status”
},
{
“name”: “createdTime”,
“alias”: “First identified on (UTC)”
},
{
“name”: “lastUpdateTime”,
“alias”: “Last identified on (UTC)”
}
],
“displayColumnSize”: 7,
“onboardType”: “manual”,
“editable”: true,
“closureCauses”: [
“Replenishment Issue”,
“Event traffic”,
“False Alert”,
“Others”
]
}

Additionally, an example alert that uses the above alert configuration is provided below.

{
“id”: “a02db3db-7eb3-41b2-8297-aeb6d6a3be01”,
“functionalAreaId”: “656c68da-251c-44dc-a20a-e01a9d8fd46a”,
“projectId”: “ebb9bd13-e4c1-41f1-b385-0563275583a5”.
“alertConfigId”: “12b30ebd-6964-40db-b515-8d7186386b16”,
“status”: “closed”,
“createdTime”: 1685626563019,
“createdDate”: “2023-09-10”,
“lastUpdateTime”: 1694523955985,
“lastUpdateDate”: “2023-09-12”,
“properties”: {
“dept_nbr”: “23”,
“dept_desc”: “MENS APPAREL”,
“item_nbr”: “990016140”,
“item_desc”: “LUXE ACTIVE SHORT”,
“start_of_day_inventory”: “0.0”,
“price”: “8.98”,
“alert_type”: “oos_alert”,
“tableau_dashboard_link”: “https://<retailer
URL>/link-to-item-inventory-tracker”,
“createdTime”: “2023-09-12 00:00:00”
},
“duplicateVersion”: 2,
“closedChannel”: “AutoClose”,
“closedTime”: 1694611981010,
“closedDate”: “2023-09-13”
}

Additionally, an example notification configuration structure associated with an alert is provided below.

“id”: “518ca154-e377-45f4-9b83-48d206ecfdb7”,
“functionalAreaId”: “eef22f19-8b6e-48d0-bc9f-59a132c06648”,
“projectId”: “6c6273e0-3b0b-403f-9d51-62dd5a148e82”,
“alertConfigId”: “877cb1db-f7f8-41c4-affa-7a29d2634e85”,
“jira”: {
“projectId”: “62805”,
“issueType”: “3”,
“assignee”: “user”,
“scheduled”: {
“enabled”: false,
“title”: null
},
“instant”: {
“enabled”: false,
“title”: null
}
},
“email”: {
“notifyTo”: [
“test@<retailer URL>”
],
“instant”: {
“enabled”: false,
“title”: null
},
“scheduled”: {
“enabled”: true,
“attachment”: false,
“sortOrder”: null,
“title”: “Alert | Item out of stock”,
“ruleEnabled”: true,
“notificationRule”: {
“rules”: [
{
“and”: {
“equalTo”: {
“values”: {
“alert.properties.dept_nbr”: “427481”,
“alert.properties.hierarchy”: “1>2>3”
}
}
},
“or”: {
“equalTo”: {
“values”: {
“alert.properties.section”: “kids-toys”
}
}
},
“title”: “Alert | Out of stock items in kids toys section”,
“notifyTo”: [
“kids-toys@<retailer URL>”, “managers-kids@<retailer URL>”
]
},
{
“and”: {
“equalTo”: {
“values”: {
“alert.properties.dept_nbr”: “110012”,
“alert.properties.hierarchy”: “1>5>8”
}
}
},
“or”: {
“in”: {
“values”: {
“alert.properties.section”: [
“men”,
“boys”
]
}
}
},
“title”: “Alert | Out of stock items in men & boys apparel section”,
“notifyTo”: [
“men-apparel@<retailer URL>”, “managers-men@<retailer URL>”
]
}
]
}
},
“firstInstance”: {
“enabled”: false,
“resetHour”: 0,
“title”: null
}
}
}

### Exemplary Operating Environment

The present disclosure is operable with a computing apparatus according to an embodiment as a functional block diagram 1600 in FIG. 16. In an example, components of a computing apparatus 1618 are implemented as a part of an electronic device according to one or more embodiments described in this specification. The computing apparatus 1618 comprises one or more processors 1619 which may be microprocessors, controllers, or any other suitable type of processors for processing computer executable instructions to control the operation of the electronic device. Alternatively, or in addition, the processor 1619 is any technology capable of executing logic or instructions, such as a hard-coded machine. In some examples, platform software comprising an operating system 1620 or any other suitable platform software is provided on the apparatus 1618 to enable application software 1621 to be executed on the device. In some examples, enabling the creation of alerts and detecting anomalies using those created alerts as described herein is accomplished by software, hardware, and/or firmware.

In some examples, computer executable instructions are provided using any computer-readable media that is accessible by the computing apparatus 1618. Computer-readable media include, for example, computer storage media such as a memory 1622 and communications media. Computer storage media, such as a memory 1622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1622) is shown within the computing apparatus 1618, it will be appreciated by a person skilled in the art, that, in some examples, the storage is distributed or located remotely and accessed via a network or other communication link (e.g., using a communication interface 1623).

Further, in some examples, the computing apparatus 1618 comprises an input/output controller 1624 configured to output information to one or more output devices 1625, for example a display or a speaker, which are separate from or integral to the electronic device. Additionally, or alternatively, the input/output controller 1624 is configured to receive and process an input from one or more input devices 1626, for example, a keyboard, a microphone, or a touchpad. In one example, the output device 1625 also acts as the input device. An example of such a device is a touch sensitive display. The input/output controller 1624 may also output data to devices other than the output device, e.g., a locally connected printing device. In some examples, a user provides input to the input device(s) 1626 and/or receives output from the output device(s) 1625.

The functionality described herein can be performed, at least in part, by one or more hardware logic components. According to an embodiment, the computing apparatus 1618 is configured by the program code when executed by the processor 1619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
provide an alert configuration interface;
receive alert configuration data associated with an alert via the provided alert configuration interface;
access a data value stored at a data source using a data path of the received alert configuration data;
analyze the accessed data value using at least one of an anomaly detection rule or a trained anomaly detection model associated with the alert;
determine that the alert is triggered based on analyzing the accessed data value; and
send an alert communication of the triggered alert using at least one alert communication channel defined in the received alert configuration data.

2. The system of claim 1, wherein the computer program code is further configured to cause the processor to utilize a generative artificial intelligence (AI) model to evaluate the alert configuration data using the data value.

3. The system of claim 2, wherein the computer program code is further configured to cause the processor to utilize the AI model to transform the configuration data received in a plain language format to a computer code format.

4. The system of claim 1, wherein the computer program code is further configured to cause the processor to analyze the accessed data value using machine learning (ML) models trained in time-series anomaly detection.

5. The system of claim 1, wherein the computer program code is further configured to cause the processor to, in response to determining that the alert is triggered, perform a de-duplication process before sending the alert communication.

6. The system of claim 1, wherein the computer program code is further configured to cause the processor to, in response to determining that the alert is triggered, log alert data related to the alert for use in providing information about business performance via a business performance interface.

7. The system of claim 1, wherein the analyzing of the accessed data value is performed by the trained anomaly detection model and comprises model training, model validation, and model deployment.

8. A computerized method comprising:
providing an alert configuration interface;
receiving alert configuration data associated with an alert via the provided alert configuration interface;
accessing a data value stored at a data source using a data path of the received alert configuration data;
analyzing the accessed data value using at least one of an anomaly detection rule or a trained anomaly detection model associated with the alert;
determining that the alert is triggered based on analyzing the accessed data value; and
sending an alert communication of the triggered alert using at least one alert communication channel defined in the received alert configuration data.

9. The computerized method of claim 8, further comprising utilize a generative artificial intelligence (AI) model to evaluate the alert configuration data using the data value.

10. The computerized method of claim 9, wherein the AI model is utilized to transform the configuration data received in a plain language format to a computer code format.

11. The computerized method of claim 8, further comprising analyzing the accessed data value using machine learning (ML) models trained in time-series anomaly detection.

12. The computerized method of claim 8, further comprising, in response to determining that the alert is triggered, performing a de-duplication process before sending the alert communication.

13. The computerized method of claim 8, further comprising, in response to determining that the alert is triggered, logging alert data related to the alert for use in providing information about business performance via a business performance interface.

14. The computerized method of claim 8, wherein the analyzing of the accessed data value is performed by the trained anomaly detection model and comprises model training, model validation, and model deployment.

15. A computer storage medium has computer-executable instructions that, upon execution by a processor, cause the processor to at least:
provide an alert configuration interface;
receive alert configuration data associated with an alert via the provided alert configuration interface;
access a data value stored at a data source using a data path of the received alert configuration data;
analyze the accessed data value using at least one of an anomaly detection rule or a trained anomaly detection model associated with the alert;
determine that the alert is triggered based on analyzing the accessed data value; and
send an alert communication of the triggered alert using at least one alert communication channel defined in the received alert configuration data.

16. The computer storage medium of claim 15, wherein the computer-executable instructions, upon execution by the processor, further cause the processor to utilize a generative artificial intelligence (AI) model to evaluate the alert configuration data using the data value.

17. The computer storage medium of claim 16, wherein the computer-executable instructions, upon execution by the processor, further cause the processor to utilize the AI model to transform the configuration data received in a plain language format to a computer code format.

18. The computer storage medium of claim 15, wherein the computer-executable instructions, upon execution by the processor, further cause the processor to analyze the accessed data value using machine learning (ML) models trained in time-series anomaly detection.

19. The computer storage medium of claim 15, wherein the computer-executable instructions, upon execution by the processor, further cause the processor to, in response to determining that the alert is triggered, perform a de-duplication process before sending the alert communication.

20. The computer storage medium of claim 15, wherein the computer-executable instructions, upon execution by the processor, further cause the processor to, in response to determining that the alert is triggered, log alert data related to the alert for use in providing information about business performance via a business performance interface.
